(19) United States
(12) Patent Application Publication
(10) Pub. No.: US 2009/0072148 A1
(43) Pub. Date: Mar. 19, 2009

(54) Method and apparatus for detecting wood eating insect infestation in enclosed shipping containers or in trees

(76) Inventor: William T. Moyer, Oak Island, NC (US)

Correspondence Address: Michael E. Mauney;Attorney at Law, P. O. Box 10266, Southport, NC, 28461, US

(21) Appl. No.: 11/901,922

(22) Filed: Sep. 19, 2007

(51) Int. Cl. G01J 5/00

(52) U.S. Cl. 250/343; 73/31.07

(57) ABSTRACT

An apparatus and method for detecting wood eating insect infestations. For trees, a baseline air sample is taken outside of the tree to determine a baseline CO2 concentration. A second CO2 sample is taken from underneath the bark of the tree. The results of the sample taken from underneath the bark of tree are compared to the baseline sample. An increased CO2 indicates a hidden wood eating insect infestation somewhere in the tree, even though the location of the infestation may be far removed from the place of sampling. For a shipping container, a baseline sample of air near the CO2 container is taken, then a sample is taken from the bottom of a shipping container. A shipping container need not be filled with wood products, rather wood products only be present as packing or support materials. The comparison is made between the baseline CO2 with the CO2 sample taken from inside the shipping container. An increased CO2 concentration is an indication of a hidden wood eating insect infestation inside the shipping container.

### RELATED APPLICATIONS

This invention grows out of research and work done in connection with my earlier invention U.S. Pat. No. 6,255,652 entitled Method and Apparatus for Detecting Insect Infestation in Enclosed Areas.

### FIELD OF THE INVENTION

This invention relates to apparatus and methods for detecting insect infestation in trees or in shipping containers.

### BACKGROUND OF THE INVENTION

Insect infestations have been a problem throughout human history. Insects such as fruit flies and boll weevils have a huge impact on agricultural industries while other insects, especially wood eating insects, have a great impact in the building industry or for wood buildings. Consequently, it is desirable to detect insect infestations in many applications.

Like all animals, insects breathe oxygen and exhale carbon dioxide. However, carbon dioxide is a naturally occurring gas and there are many other sources for carbon dioxide other than insects. For example, all animals exhale carbon dioxide and internal combustion engines produce carbon dioxide. Because of the interference of background CO2 produced by sources other than insects, detecting insects using CO2 has proven difficult or impractical for many applications.

In order to overcome the difficulty of determining the source of a common gas like CO2 some systems have been proposed which use less common gases that may be specific for a particular insect pest. For example, Martin et al, U.S. Pat. No. 6,150,944 proposes a termite detection system to detect the presence of naphthalene, aristolene, calarene, along with other gases. By focusing on detection on gases that are specific to termites, the difficulty of contamination by common background gases, which is a problem in detection based on CO 2 emissions by termites, is eliminated.

Another solution proposed to eliminate the problem of contamination by background gases especially by CO2 in insect detection can be seen in Bruce et al, U.S. Pat. No. 3,963,927. Here, a sample of a material in which an insect infestation is suspected is sealed in a chamber. The air inside the chamber is held stable for an interval of time which then moves through the detection system as a plug flow or bolus through an infrared analyzer. A sample chamber in which the material to be tested is placed is first purged with a carrier gas and then sealed off for a long enough time to allow respired CO2 by insects contained within the sample material to build up and reach a concentration sufficient for detection. Similar to the Bruce U.S. Pat. No. 3,963,927 is Delgrasso, U.S. Pat. No. 4,206,353. Delgrasso uses a closed chamber like the Bruce patent with an incubation time and purge by baseline or reference gas. These devices find their greatest use with a commodity, such as wheat or rice, where a sample may be taken from a much larger specimen.

A variation of the above approaches can be seen in devices which use a bait container. For example, in Lake, U.S. Pat. No. 6,323,722, a block of wood is placed inside a container which includes conductive loops. An electrical circuit may be interrupted by the termites within the block of wood leading to detection of termites. A similar approach is seen in Washburn, U.S. Pat. No. 6,374,536, where a bait station is used to lure termites into the bait station. In Washburn, the tell tale gas, methane, produced by the termites is detected within the bait station.

In addition to termites, there are a number of other pest insects which eat wood. For example, there is the emerald ash borer, the Asian longhorned beetle, and the pine bark beetle. These insect pests may attack a living tree, be present in wood from a tree, or in lumber. Oftentimes the presence of these insects cannot be detected by visual inspection until the health of the tree is affected to such a degree that the leaves turn yellow or the tree begins to die. Additionally, wood is frequently used in shipping. For example, wood is used in pallets on which goods rest or can be used as bracing inside a shipping container. Since sealed containers are frequently shipped internationally, this leads to a risk of the introduction of exotic wood destroying or wood eating insects into a new environment. A recent introduction of an exotic insect into the United States, which is proving to be an economic problem, is Formosan termites. Alien insects from other parts of the world introduced to the United States often create special problems. In their indigenous environment, the insect will have natural predators or other natural control means. But once introduced into the United States, these alien insects may have unchecked growth.

Currently trees are inspected for insect infestation by visually inspecting the tree. Trees are large plants and an insect infestation may be active in a portion of the tree which is many feet removed from the ground. This requires special equipment to visually inspect the trees. Motorized lift vehicles known as “cherry pickers” are sometimes used. An individual may also climb a tree using special equipment. However, even a close visual inspection may not reveal hidden insect infestations. The Southern Pine bark beetle will ordinarily show visible signs of insect infestation in a pine tree. However, many other insects are not detectable until the infestation begins to affect the health of the tree. Currently, containers are randomly inspected with only a small number of the total amount of the containers in a given shipment subject to inspection. Many shipping containers are shipped with seals to prevent pilferage or alteration of the contents of the containers. When shipping containers arrive, an Agricultural Department inspector, customs inspector, or a homeland security inspector may inspect inside the sealed shipping container. Observation of insect infestations is a secondary part of the inspection since inspectors are primarily looking for different things depending on the purpose of the inspection. An agricultural inspector may be looking for prohibited food products. A customs inspector may be more interested in customs duties or taxes. A homeland security inspector may focus on threats on homeland security, such as prohibited weapons, toxic agents, or the like. Consequently, wood used for packing or bracing is, at best, a secondary aspect of the inspection. For this reason, inspection of shipping containers rarely uncover exotic wood eating insect infestations.

Consequently, it would be an advance in the art if there were a means of readily detecting termites or other wood eating insects when present in trees or wood material used in shipping containers. There is currently no practical method which accomplishes this detection.

### SUMMARY OF THE INVENTION

It has been unexpectedly found that increased concentrations of CO2 can be detected in trees or closed shipping containers to indicate an active insect infestation. By appropriate sampling methods, increased concentration of CO2 is a tell tale sign of a wood eating insect infestation. Increased CO2 concentrations suggest further invasive tests to more definitively establish an insect infestation. The current invention uses an intake pump connected to an intake nozzle. The pump will pull air through an intake nozzle into an infrared carbon dioxide detector. For detection to take place, there is first a baseline reading taken in the ambient air. Once a baseline reading is obtained the pump will be turned off. Air from the areas of suspected infestation will then be sampled using the intake pump. A small needle or larger probe may be used as an intake nozzle to penetrate the space to be sampled whether it is inside a shipping container or underneath the bark of a tree. Once the nozzle is in place, the intake pump is again activated, sampling the air in the area of suspected infestation. An increase of several parts per million of CO2 is enough to indicate a wood eating insect infestation. A positive reading can lead to further investigation such as opening and visually inspecting the wood inside a container or carefully inspecting a tree including removing portions of the bark to check for active insect infestations.

### BRIEF DESCRIPTION OF THE DRAWINGS

FIG. 1 shows a schematic diagram of the apparatus of this invention.

FIG. 2 shows a stylized version apparatus of this invention.

FIG. 3 shows this invention in use with a tree.

FIG. 4 shows this invention in use with a shipping container.

FIG. 5 shows this invention in use with a modified shipping container.

### DETAILED DESCRIPTION OF THE DRAWINGS

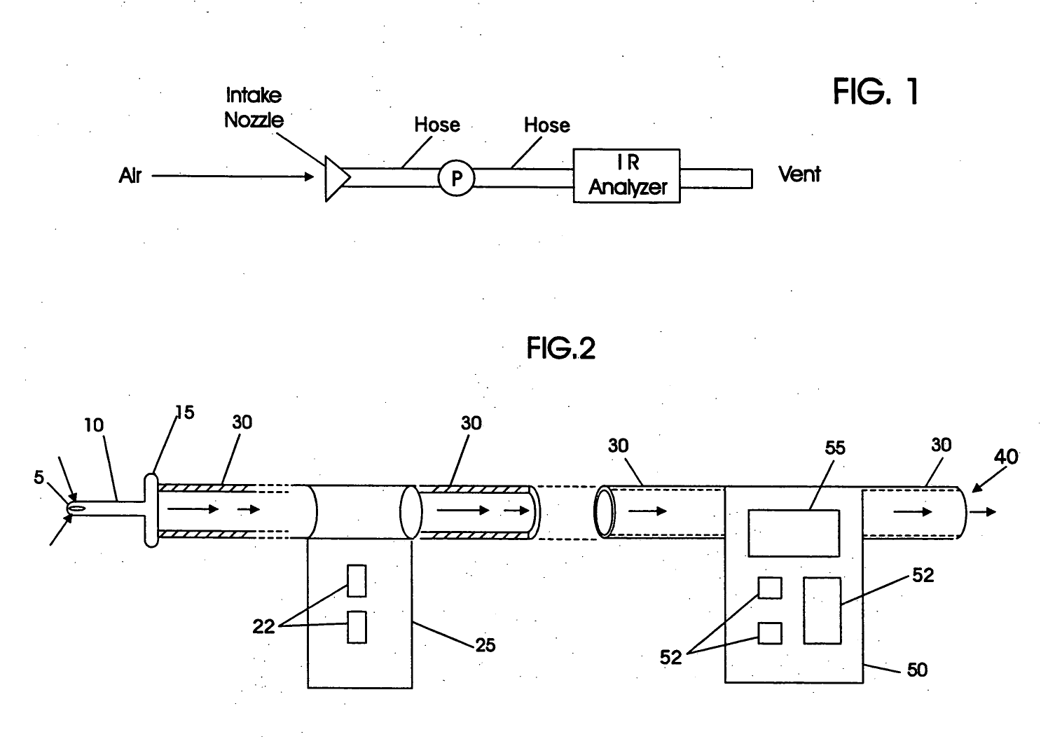

FIG. 1 is a schematic diagram of the apparatus of this invention. At one end of the invention is an air intake nozzle. It is connected to an infrared analyzer. The infrared analyzer samples the air coming from the air intake nozzle. Analyzed air escapes from the system through a vent. Ordinarily the device will require some way of moving air from the intake nozzle across the infrared analyzer. This will ordinarily be a pump. In FIG. 1 the pump (P) is shown positioned between the intake nozzle and the infrared analyzer. It is connected to each by flexible airtight hoses. However, this arrangement is a matter of convenience. The device could be made of one piece with an intake nozzle appearing as a hollow probe leading to an infrared analyzer with a pump to move the gas or air to be sampled. In order for the apparatus to operate, it only requires that air being pulled into the infrared analyzer is segregated from outside ambient air. This assures that the air sample analyzed will have the ability to detect an increased CO2 concentration in the event of a hidden insect infestation.

To operate the current apparatus, it is first necessary to obtain a baseline reading of the CO2. First, ambient air is sampled in the vicinity of the tree or shipping container where there is a suspected wood consuming insect infestation. This established a baseline CO2 reading. Then a sample is taken from the enclosed area where the wood consuming insect infestation is suspected. This sampled air is analyzed by the infrared analyzer. The CO2 content of the sample is compared to the CO2 content of the baseline gas. An increased CO2 reading may be an indication of an active insect infestation in the area where the sample was taken.

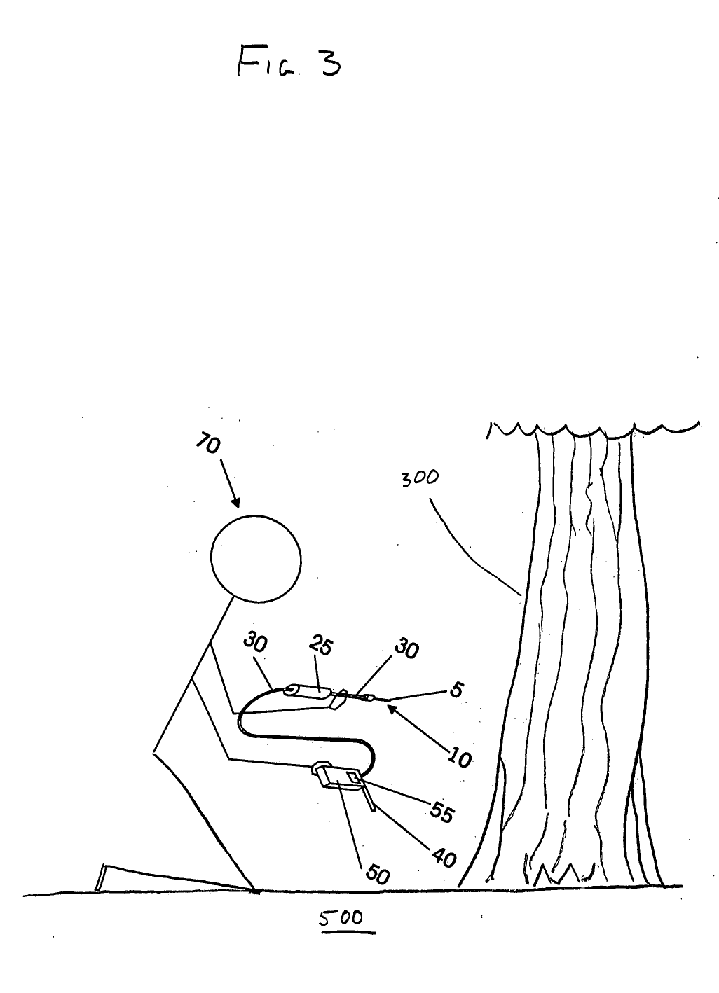

FIG. 2 shows an apparatus to practice the method of the current invention. At one end is an intake nozzle (10). This consists of a hollow needle with an air intake opening (5) at the end of the intake nozzle (10). The dimensions of the intake nozzle (10) can vary depending on the need to sample. In a container, the intake nozzle may be a meter or more in length. In other applications a hollow needle of the type used to inflate athletic equipment such as basketballs or footballs may work well. At the base of the intake nozzle (10) is a rubber gasket (15). The intake nozzle (10) is inserted into an area to be sampled. There may be a rubber gasket (15) at the base of the intake nozzle (10) to prevent ambient air from being pulled through the intake nozzle (10) along with the area of confined air to be sampled. A pump (25) is connected to the intake nozzle (10) by a flexible hose (30) which is shown in cutaway in the first part of FIG. 2. The pump (25) is controlled by the buttons (22). Air flows through the apparatus as indicated by the arrows to the intake opening (5) inside the hose (30) to the infrared analyzer (50). The infrared analyzer (50) will have an output screen (55) which may give a reading of the CO2 concentration of the sample taken. The operation of the infrared analyzer (50) is controlled by the buttons (52) in front of the infrared analyzer (50). The sampled air exits through the vent (40). The device currently being sold by Termite Detection Inc. has been found to work well in practice for sampling of CO2 in the space in between the wall studs and behind paneling or wall board in a home. An infrared analyzer ordinarily can be modified using different gas detection modules so that not only CO2 concentration can be detected, but also methane, carbon monoxide or other gases.

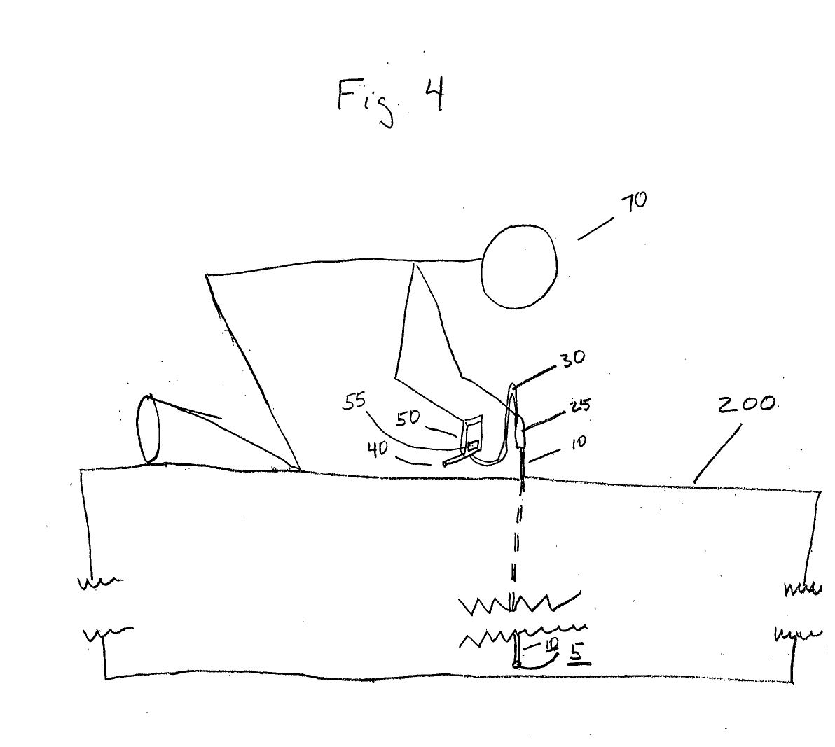

FIG. 3 shows the apparatus used to practice the method of the current invention with a tree. An operator (70) is kneeling on the ground (500) near the base of a tree (300). Held in the operator's hands is the pump (25) which will pull air through the intake opening (5) in the intake nozzle (10) into the flexible hose (30) and across the detector module in an infrared analyzer (50). An output reading is shown on the output screen (55). As the gas crosses over the infrared analyzer (50), it will be blown out of the flexible hose (30) at vent (40). The fact that increased CO2 concentrations can be found inside the bark at or near the base of a tree when the tree is infested with wood eating insects is a surprising result. It is known that CO2 is heavier than air and will sink to the ground or to the lowest declivity. However, trees, unlike animals, inspire CO2 and through photosynthesis convert it into carbohydrates and release oxygen into the atmosphere. The living layer under a tree bark, the cambia, is an active part of the tree involved in transport of nutrients and water from the ground into the leaves of a tree. The cambria may also transport CO2 from high in a tree to the trunk at ground level. Also it is known that all animals produce CO2. However, it appears that wood eating insects produce a higher concentration of CO2 than may be common in other insects that may be present in the tree, but which do not actively ingest the wood. For example, carpenter ants make a home in wood by channeling or cutting openings or a chamber in the wood. However, they do not appreciably increase the CO2 level even though they do actively breathe in oxygen and breathe out CO2. However, it has been found in practice that elevated CO2 level in the base of a tree is a reliable indicator of the infestation of the tree by insects that consume wood. It need not be termites, but can be pine bark beetles or other wood consuming insects. A drill (not shown) will be used by the operator (70) to drill a hole at or near the base of a tree (300). The intake nozzle (10) in FIG. 3 is not shown to scale. For use with a tree (300), the intake nozzle (10) will be a hollow, stainless steel probe approximately 18 inches in overall length. The approximate 18 inches of the intake nozzle (10) allows it to be used just beneath the bark of the tree (300) or to penetrate deep into the tree for the sampling. As is described for FIG. 1, first a sample of the ambient air outside of the tree is taken to establish a baseline reading, then a sample of air is taken from within the tree. An increased CO2 concentration provides a reliable indication of insect infestation. Consequently, being able to check a tree for wood eating insect infestations without requiring a visual inspection, especially for parts of the tree far removed from the ground, and a means to detect otherwise hidden insect infestations, is a significant advance over current means of visual inspection for finding insect infestations in trees.

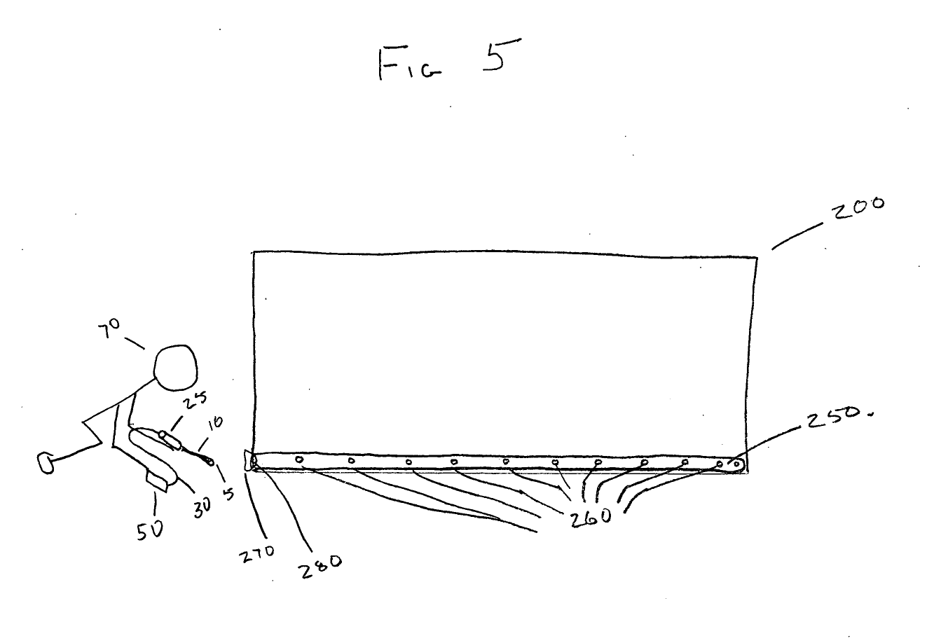

FIG. 4 shows a sample taken from inside a shipping container (200). The operator (70) is shown on top of the shipping container (200). Here, the intake nozzle (10) extends into the shipping container (200) from a hole made in the top of the shipping container (200). Some shipping containers come with a small hole in the top for ventilation purposes. The intake nozzle (10) must be long enough to reach to near the floor of the shipping container (200) where the intake opening (5) is shown near the floor of the shipping container (200). If the shipping container (200) does not have a hole in the top which is suitable for use with the intake nozzle (10), then a hole can be specially drilled in the shipping container (200) for use for the sampling. As before, the infrared analyzer (50) is shown in one hand of the operator (70). The infrared analyzer (50) is connected to the pump (25) by the flexible hose (30). The pump (25) which connects to the intake nozzle (10). Shipping containers (200) are used to ship equipment, machinery, or smaller containers of manufactured goods or raw materials. Sometimes the contents of the shipping containers (200) are placed on wooden pallets or pieces of wood, including tree branches, are used to brace the contents of the shipping container (200) into place so the contents will not be dislodged or damaged during transit. The wood used inside the shipping container (200) for bracing or pallets is incidental to the contents of the shipping container (200), but nevertheless may contain wood eating insects. Surprisingly, these wood eating insects produce a sufficient amount of CO2 so increased concentration of CO2 can be readily detected without opening and visually examining the wood inside the shipping container. If there is no increased concentration of CO2 inside the shipping container (200), then no insects are present and no more detailed or internal inspection is required. This device allows the container to be checked for active wood eating insect infestations without breaking the seals. Indeed, many seals will allow a small enough crack in the door of the container to allow a probe to be inserted inside the container for sampling of the air inside the container. Containers are typically packed in a manner to maximize use of the container, which can make it difficult to observe inner portions of the container which may be filled with goods. Consequently, it is estimated that less than one in twelve insect infestations are discovered even if containers are usually inspected. Consequently, use of this invention will greatly improve the likelihood of detecting wood eating insects in a shipping container.

FIG. 5 shows the current invention in use with a modified shipping container (200). In this application it is assumed this is shipping container (200) is the type of shipping container used for international shipments. International shipping containers (200) are of a standardized size and shape, approximately the size of a small trailer that might be used in conjunction with a cargo carrying long distance truck. These containers (200) may be loaded onto railroad cars or the back of trucks for ground shipment. Typically, large cranes load them onto specialized ships where the containers (200) are stacked high on the deck or in the hold of a ship for international shipping. In order to facilitate the shipping across national borders, the containers (200) must be standardized size and shape to be widely used throughout the world for international shipping. It is believed with this type of shipping container (200) this invention will find its widest use since this invention prevents accidental shipment of wood eating insects, especially shipment of wood eating insects into an area where they do not exist. Because these shipping containers (200) are of a set size, shape, and construction, it is possible a shipping container (200) accessory could be designed specifically with a small tube (250) that would run along at least a portion of the inside floor of the shipping container (200). This tube (250) would be pierced with a plurality of openings (260). Openings would allow the heavier-than-air gas, carbon dioxide to accumulate within the tube (250). There would be a sampling port (270) for receipt of the intake nozzle (10) of the current invention. There could be a rubber gasket (280) which would allow for easy penetration of the intake nozzle (10) while retaining the accumulated carbon dioxide within the tube (250). This modified shipping container (200) would allow an operator (70) to use the current invention to readily sample a shipping container (200) while sampling can be accomplished without use of the tube (250), it is anticipated the tube (250) will provide more and greater accuracy and facilitate sampling for containers (200) that need to be tightly sealed or where other sampling methods may prove inappropriate or impractical.

I claim:

1. An apparatus for detecting hidden remote wood eating insect infestations in trees by detecting increased levels of CO2 gas at the base of a tree removed from remote insect infestations comprising:
(a) a CO2 gas analyzer;
(b) a pump used in conjunction with said CO2 gas analyzer whereby CO2 gas is sampled from inside of a tree at the base of the tree in proximity to ground and passed through the CO2 gas analyzer;
(c) a nozzle connected to an intake side of said pump whereby when said pump is activated to withdraw CO2 gas from inside of a tree and to pass it over said CO2 analyzer, an increased CO2 concentration indicates a wood eating insect infestation remote from said sample location at said base of said tree.

2. An apparatus for detecting hidden wood eating insect infestations in trees by detecting increased levels of CO2 gas of claim 1 which further comprises means for sampling CO2 gas from beneath bark of a tree.

3. An apparatus for detecting hidden wood eating insect infestations in trees by detecting increased levels of CO2 gas of claim 2 wherein said means for sampling comprises insertion of said nozzle beneath bark of a tree.

4. An apparatus for detecting hidden wood eating insect infestations in trees by detecting increased levels of CO2 gas of claim 3 wherein said CO2 analyzer is an infrared gas analyzer.

5. An apparatus for detecting hidden wood eating insect infestations in trees by detecting increased levels of CO2 gas of claim 4 wherein said nozzle is a hollow tube.

6-12. (canceled)

13. A method for detecting hidden wood eating insects in a tree comprising:
(a) detecting a baseline concentration of CO2 in first area near a tree, said tree with a suspected wood eating insect infestation;
(b) drilling a hole beneath bark of said tree;
(c) inserting an intake nozzle into said tree with a suspected hidden wood eating insect infestation into said hole beneath bark of said tree;
(d) withdrawing air from said tree with a suspected hidden wood eating insect infestation;
(e) measuring the CO2 content of the withdrawn air with a gas analyzer;
(f) comparing the CO2 concentration in step (a) to the CO2 concentration in step (d) to determine if there is an increased amount of CO2 in the area sampled;

14. (canceled)

15. A method for detecting hidden wood eating insects in an area of claim 13 further comprising said step of measuring said CO2 content of said air is performed by an infrared gas analyzer.

16-17. (canceled)
